(19) United States
(12) Patent Application Publication
(10) Pub. No.: US 2013/0224973 A1
(43) Pub. Date: Aug. 29, 2013

(54) ELECTRICAL DEVICE, IN PARTICULAR A SOCKET AND CONNECTOR, HAVING A SECONDARY LOCK, METHOD FOR MOULDING SUCH A DEVICE AND MOULD FOR PRODUCING SUCH A DEVICE

(71) Applicant: Olivier Midy, Rochefort sur Loire (FR)

(72) Inventor: Olivier Midy, Rochefort sur Loire (FR)

(73) Assignee: TBI, Les Neyrolles (FR)

(21) Appl. No.: 13/635,564

(22) PCT Filed: Mar. 17, 2011
(86) PCT No.: PCT/FR2011/050546

§ 371 Date: Dec. 11, 2012

(30) Foreign Application Priority Data
Mar. 17, 2010 (FR) 1051877

(51) Int. Cl. H01R 13/453; B29C 45/33

(52) U.S. Cl. CPC H01R 13/4538; B29C 45/33
USPC 439/137; 264/328.7; 425/542

(57) ABSTRACT

an electrical device has a first portion intended for receiving a complementary electrical lamp and a fixed connector intended for receiving power supply wires extended by at least one contact leading into said first portion, the fixed connector including a lock that is only activated when the contacts are correctly inserted in the fixed connector, the first portion, the fixed connector and the lock thereof being moulded simultaneously, the lock being is made up of a slide translatably mobile relative to the fixed connector between a retracted position permitting the insertion of contacts, and a locked position in which a shutter prevents the removal of the contacts. a method for moulding such a device and a mould for producing such a device, are also enclosed.

### CROSS-REFERENCE TO RELATED APPLICATIONS

This application is a National Phase Entry of International Application No. PCT/FR2011/050546, filed on Mar. 17, 2011, which claims priority to French Patent Application Serial No. 10/51877, filed on Mar. 17, 2010, both of which are incorporated by reference herein.

### FIELD OF THE INVENTION

The invention relates to the field of electrical connection equipment, and more particularly electrical sockets and connectors.

### BACKGROUND

So-called “double-lock” connectors are known in the state-of-the-art. Such connectors include a portion which can be triggered, after the mounting of connecting wires, only when the electrical contacts are properly positioned. If the contacts are incorrectly inserted, they prevent the closing of such locking portion, thus demonstrating the assembling error.

The international patent WO8606555, which describes a double lock electrical connector, is more particularly known in the state of the art. Such connector of the prior art includes a recess provided with throughholes, with each one receiving a pin plug having a limiting tab which can be removed by moving the pin plug axially relative to the recess. Such connector has a secondary locking member including a series of insertion parts provided with channels and extending a plate provided with locks for fixing the locking member with the recess. Each insertion part is provided with tips going beyond the channel walls and being inserted behind a coupling portion of the pin plug in order to prevent any backward motion, while leaving sufficient clearance for a top cap extending the rear of the limiting tab.

Another patent published with number FR 2723802 discloses a high-reliability connector. A first connector structure intended to be coupled with a complementary connector structure includes first and second housings which make up a secondary locking mechanism. The first housing includes a resilient detent finger for locking the first connector structure on a detent protrusion of the second connector structure. If the first and second housings are not totally assembled, the connector structures cannot be assembled since the front end of the detent finger comes in contact with a stop and cannot be moved.

The French patent FR 2887080 discloses a connector of the toggle type making it possible to let the electric wires out on either side of the housing of such connector and prevent the wire cover from being locked with the housing when such cover is mounted in the opposite direction. For this purpose, the toggle and the wire cover are provided with means preventing the locking of the cover with the housing in case of an incorrect assembling.

The European patent EP0726617 discloses a connector including a housing for receiving terminals, a secondary locking element able to be mounted on the housing and a sliding locking element of the bayonet type to perform the connection of the connector to a complementary connector. In the pre-assembling position, the sliding locking element is in a totally closed position where shoulders cooperate with latches of the secondary locking element which is a pre-assembling position enabling terminals to be received in a cavity of the connector housing. When the secondary locking element is lowered into the totally locked position, the latches are released from the shoulders of the sliding locking element, which enables the latter to be opened in order to allow connection with the complementary connector. As the sliding locking element is in the totally closed position when the secondary locking element is in a pre-assembling position, the connection between the connector and a complementary connector is prevented, and more particularly even a partial connection is prevented when the contact pads of the complementary connector cannot be inserted into the cam-forming slots.

The solutions of the prior art make it possible to provide a safe assembling, but use several complementary parts. These various parts must be pre-assembled, which requires expensive manual or automatic operations and the management of several stocks of parts, as well as assembling machines. In the case of connectors where the double locking function is provided by a hinge, the latter locally limits the percent load of glass fibre or of the equivalent material and thus does not make it possible to make parts having a high thermal resistance for a low cost.

### SUMMARY

The present invention aims at remedying the drawbacks of the prior art. For this purpose, the invention, in its broadest sense, relates to an electrical device having a first portion intended for receiving a complementary electrical means and a fixed connector intended for receiving supply wires extending through at least one contact opening into said first portion, with the fixed connector including locking means which can be actuated only when the contacts are properly inserted in said fixed connector, with the first portion, the fixed connector and said locking means being simultaneously moulded, with said equipment being characterized in that said locking means is made up of a slide translatably mobile relative to said fixed connector between a retracted position permitting the insertion of contacts, and a locked position in which said shutter prevents the removal of said contacts.

Preferably, said fixed connector has two guiding means which are not parallel to the contact insertion axis, and in that said slide has complementary means for providing the translational guiding on the inner surface of the sides thereof. Advantageously, said protrusions are so configured as to enable, during moulding, the insertion of the moulding tools along two perpendicular directions in order to form, upon unmoulding, two parts mobile relative to each other, along a motion path which is limited by a motion limit stop.

According to a preferred embodiment, the inner surface of the fixed connector has a stop substantially perpendicular to the direction of the motion of said slide coming into contact with side hooks provided on the inner surface of the sides of the slide when said slide is in retracted position. According to a first application, the front portion is intended for receiving the base of an electric lamp, with said equipment constituting an electrical socket. According to a second application, the front portion of said first portion is intended for receiving a complementary connection member, with said equipment constituting an electrical connector.

### BRIEF DESCRIPTION OF THE DRAWINGS

The present invention will be better understood upon reading the following description with reference to the accompanying drawings of non limiting embodiments of the invention, given solely by way of examples. In these drawings:

FIG. 1 shows a three-quarter back view of an exemplary embodiment of a socket, with the locking slide in retracted position;

FIG. 2 shows a three-quarter top view of an exemplary embodiment of a socket, with the locking slide in retracted position; and

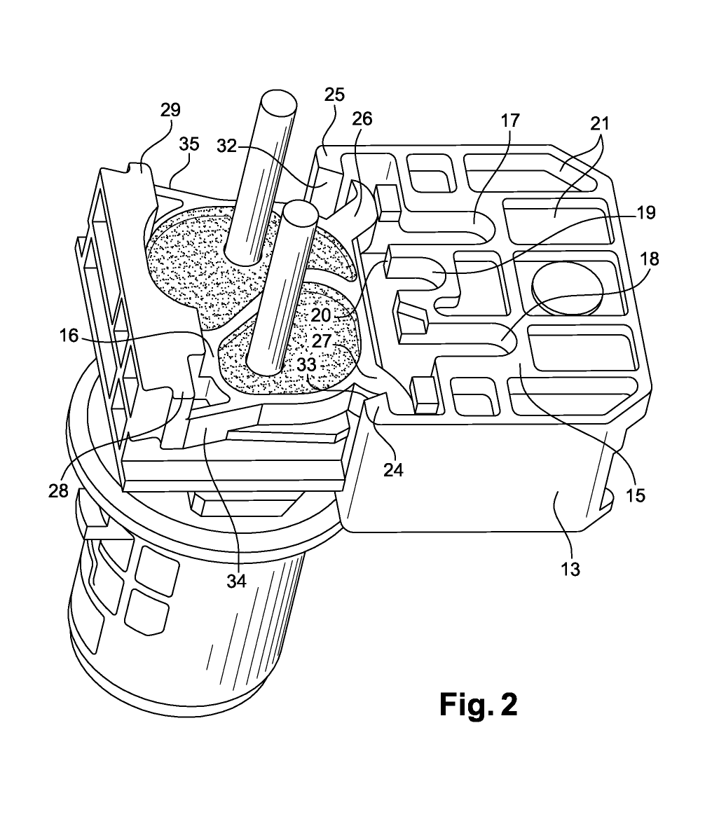

FIG. 3 shows a three-quarter bottom view of an exemplary embodiment of a socket, with the locking slide in retracted position.

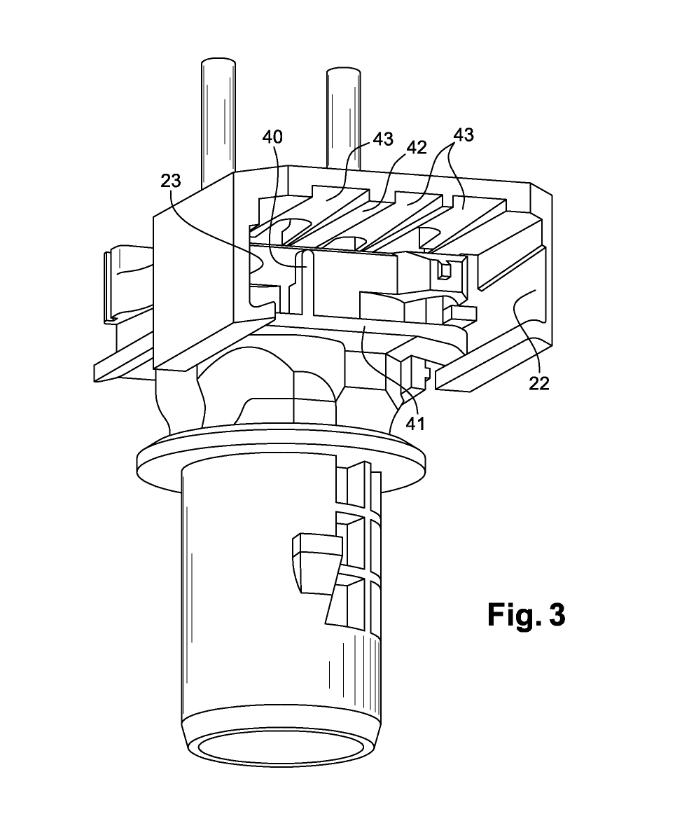

### DETAILED DESCRIPTION

The present description relates to an exemplary embodiment as a socket for a so-called “Wedge base” clipped electric lamp. It is intended for receiving an electric lamp of the W5W type. The socket is made up of two portions:
a first portion 1 intended for receiving the base of the lamp;
a fixed connector 2 intended for connecting the electric wires; and
a slide 3 made up of a translatably mobile portion relative to the fixed connector.
   The three parts 1 to 3 are produced by moulding in a single mould, making it possible to produce a part requiring no assembling operation.

### First Portion Receiving The Base Of The Electric Lamp

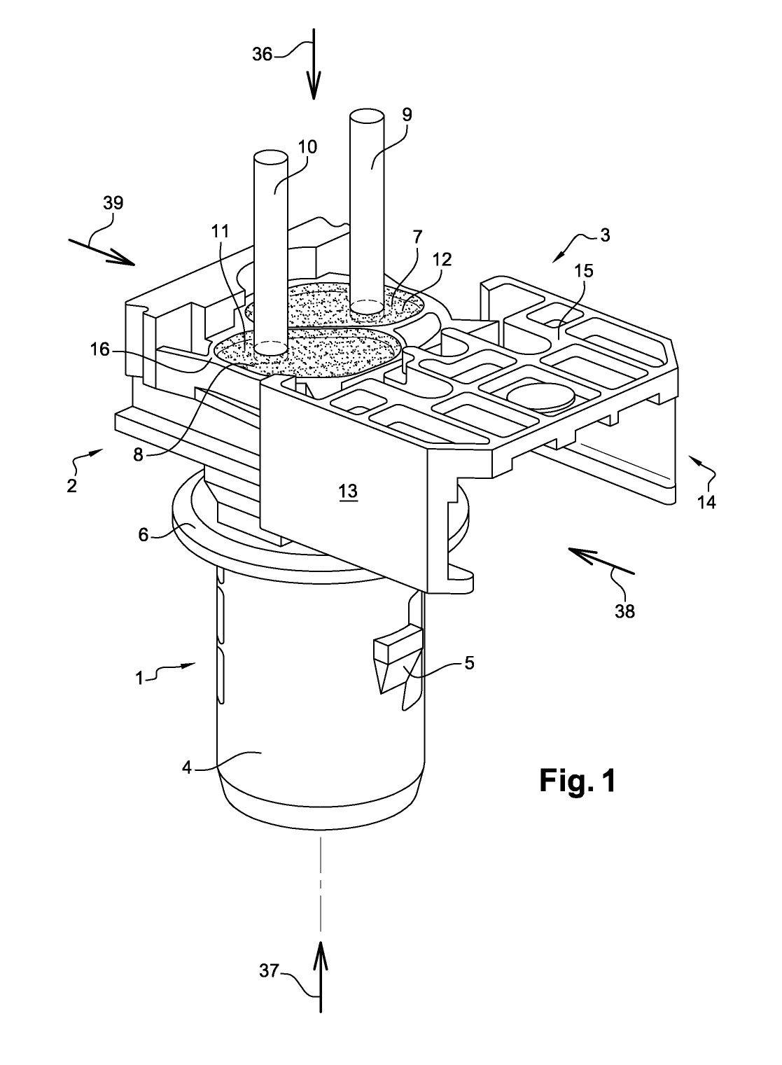

The first portion 1 has a tubular body 4, the inner section of which is complementary to the base of the lamp. Such portion shall not be described in greater details since it complies with the prior art and it is generally standardised to enable a perfect interoperability with the corresponding lamps. The tubular body 4 has, in the disclosed example, pins 5, only one of which can be seen in FIG. 1. Such pins 5 make up, with the collar 6, the bayonet assembling means on a counterpart, for example a headlamp or traffic signals housing.

### Fixed Connector Providing The Electric Connection

The fixed connector 2 has two cavities 7, 8, the axes of which are co-linear with the axis of the tubular body 4. The axes of the cavities 7, 8 are symmetrically offset relative to the axis of the tubular body 4. Such cavities 7, 8 are intended for receiving electrical contacts equipped, in the disclosed example, with gaskets (11, 12) providing tightness between the electric wire 9, 10 and the inlets of the cavities 7, 8, respectively.

Upon assembling, the assemblies grouping one electric wire 9, 10 each, crimped on a contact and surrounded, in the disclosed example, by a gasket 11, 12, are introduced. Such assemblies are introduced into the cavities 7, 8 up to the nominal position where they are locked by an inner clipping means provided in the contacts and the cavities. An essential challenge of such assembling is to guarantee the correct insertion of each assembly. If the insertion is not correct, the electrical and mechanical contact between the lamp and the power supply is not correct and causes malfunction such as the defective power supply of the lamp, the fall of the lamp or an intermittent contact, which could cause a detrimental heating.

In order to check the insertion of such assemblies in the cavities, the socket further includes a slide 3 having a double function. Such slide provides a secondary locking, which completes the locking provided by the cooperation between the connection assemblies and the cavities when it is pushed back above the cavities. It also checks the assembling: if the contacts are not correctly positioned, it cannot be pushed back in locking position, which is the obvious, easily seen demonstration that the assembly is not correct.

### Mobile Slide

The mobile slide 3 is made up of a hollow portion having two sides 13, 14 connected by an upper surface 15 liable to cover the upper surface 16 of the fixed connector 2. The upper surface 16 has two notches 17, 18 the width of which substantially corresponds to the diameter of the electric wires 9, 10. Such notches open on the front edge 20 of the upper surface 15, in order to enable the insertion of the wires into such notches when the slide 3 is pushed back into the locking position. A third notch 19 is provided to enable the passage of a third so-called “take-over” wire through one of the gaskets 12 when such alternative solution is implemented.

The upper surface 15 has compartments 21 intended for making the part lighter while providing sufficient rigidity through the partitions, having a constant thickness, which separates said compartments. The thickness of the upper surface 15 varies between a minimum thickness of 0.8 mm for the compartments 21 and a maximum thickness between 2 mm and 2.5 mm for said partitions. A large rib 22, 23, the width of which matches the thickness of the fixed connector 2 is provided on the inner surface of the sides 13, 14 in order to provide translational guiding.

In the example disclosed, the guiding direction is perpendicular to the axis of the cavities 7, 8 and to the tubular body 4. But the guiding direction could be inclined relative to such axes, in alternative embodiments. The front portion of the sides is provided with hooks 24, 25 perpendicular to the direction of the slide 3 translation.

Such hooks form a holding means cooperating with complementary hooks 26, 27 provided on the fixed connector 2. Such respective hooks 24, 25 and 26, 27 are so configured as to limit the back travel of the slide 3 and prevent it from being retracted relative to the fixed connector 2. The hooks 24, 25 formed on the slide 3 has a chamfer 32, 33 oriented toward the fixed connector 2, in order to provide a forced passage at a protrusion 28, 29 provided on the fixed connector 2 and provide for the clipping and the locking of the slide 3 on the fixed connector 2. Such protrusions 28, 29 have two chamfers 34, 35 parallel to the chambers 32, 33 in order to enable the insertion of the sides 13, 14 of the slide 3 by deformation.

The fixed connector 2 further has a hook 40 extending perpendicularly to the surface of the bottom 41 of the fixed connector 2, in the middle between the wire passage 18 and the wire passage 19. It extends up to a distance of approximately one millimetre from the ceiling 42 of the slide 3. Such hook 40 prevents the falling of the slide by limiting the rotation range of the slide 3 relative to the fixed connector 2, in the direction 36. The ceiling 42 further has closing slopes 43 oriented in the direction of the translation of the slide, and forming a slope of approximately a few degrees, for instance 3 to 5° with the transversal plane.

### Part Moulding

The hooks are formed upon moulding in a mould having two perpendicular motion axes, i.e.:
a main moulding motion in two opposite directions 36, 37. The direction of such main motion is parallel to the main axis of the socket barrel 4.
a secondary moulding motion in two opposite directions 38, 39. The direction of such secondary motion is parallel to the slide 2 motion axis.

The part is moulded in a position where the slide is retracted backwards, with some clearance. A void remains in the transversal plane between:
the cutting edge of the hooks 26, 27 of the fixed connector 2, on the one hand and the inner surfaces of the sides 13, 14 of the slide 3, on the other hand. Such space is defined by a portion of the mould mobile in the direction 36.
the outline of the hooks 26, 27 of the fixed connector 2, on the one hand, and the outer surface of the hooks 24, 25 of the slide 3, on the other hand. Such space is defined by a portion of the slide mobile in the direction 36.
the passages 17 to 19 and the front face of the upper surface 15, as well as the compartments of the upper surface 15 of the slide, and the cavities 7, 8 of the fixed connector 2 and the hooks 28, 29 of the fixed connector 2. Such elements are defined by a portion of the mould mobile in the direction 36.

According to the secondary motion, the mould provides spaces between:
the lower and upper surfaces of the hooks, on the one hand, and the adjacent surfaces on the other hand;
the surface of the fixed connector 3 and the ceiling 42 of the slide 3; and
the inner shapes of the slide 3.
   The motions 38 and 39 make it possible to separate the hooks 24, 25 from the fixed connector 2. The mould includes two main blocks mobile along two longitudinal axes, with the rear block having two pin assemblies mobile along a longitudinal axis, with the mould further including two transversely mobile blocks, with the front block having two blades mobile along two transversal axes.

The invention is described in a non-limiting exemplary embodiment. It can be executed as connectors, in this case, the slide provides the additional visible locking of the contacts of a male or female connector.

1. An electrical device comprising a first portion adapted for receiving a complementary electrical lamp and a fixed connector intended for receiving supply wires extending through at least one contact opening into said first portion, with the fixed connector including a lock which can be actuated only when the contacts are properly inserted in said fixed connector, with the first portion, the fixed connector and the lock being simultaneously moulded, the lock further comprising a slide translatably mobile relative to the fixed connector between a retracted position permitting the insertion of contacts, and a locked position in which a shutter prevents the removal of the contacts, with the fixed connector and the slide being mobile relative to each other, along a motion path limited by a motion limit stop.

2. An electrical device according to claim 1, wherein the said fixed connector has two guides which are not parallel to the contact insertion axis, and the slide has complementary means for providing translational guiding on the inner surface of the sides thereof.

3. An electrical device according to claim 2, wherein the guides are configured as to enable, during moulding, the insertion of moulding tools along two perpendicular directions in order to form, upon unmoulding, two parts mobile relative to each other, along a motion path which is limited by a motion limit stop.

4. An electrical device according to claim 3, wherein the inner surface of the fixed connector has a stop substantially perpendicular to the direction of the motion of the slide coming into contact with side hooks provided on the inner surface of the sides of the slide when the slide is in retracted position.

5. An electrical device according to claim 1, wherein the front portion of the first portion is adapted for receiving a complementary connection member, with an electrical connector.

6. An electrical device according to claim 1, wherein the front portion is adapted for receiving a base of the electric lamp, and with the electrical device is an electrical socket.

7. An electrical socket comprising a fixed connector including two cavities, the axes of which are co-linear with an axis of a tubular body, and the axes of the cavities being symmetrically offset relative to the axis of the tubular body.

8. An electrical socket according to claim 6, wherein the mobile slide includes portion having two sides connected by an upper surface liable to cover the upper surface of the fixed connector.

9. An electrical socket according to claim 8, wherein the upper surface has two notches the width of which substantially matches a diameter of electric wires, with such notches opening on a front edge of the upper surface, in order to enable the insertion of the wires into such notches when the slide is pushed back into a locking position.

10. A method for moulding an electrical device according to claim 1, the method comprising injecting a plastic material is into a mould having four blocks mobile along two perpendicular motion axes, i.e. a main moulding motion along two opposite directions and a secondary moulding motion along two opposite directions, with the direction of the main motion being parallel to the main axis of electrical equipment and the direction of the secondary motion being parallel to the axis of motion of the slide.

11. A mould for implementing the moulding method according to claim 10, the mould further comprising two main blocks mobile along two longitudinal axes, with the rear block having two pin assemblies mobile along a longitudinal axis, with the mould further including two transversely mobile blocks, with the front block having two blades mobile along two transversal axes.
